(19) United States
(12) Patent Application Publication
(10) Pub. No.: US 2009/0113137 A1
(43) Pub. Date: Apr. 30, 2009

(54) PSEUDO LEAST RECENTLY USED (PLRU) CACHE REPLACEMENT

(76) Inventors: Brian C. Grayson, Austin, TX (US); Klas M. Bruce, Leander, TX (US); Anhdung D. Ngo, Austin, TX (US); Michael D. Snyder, Cedar Park, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/929,180

(22) Filed: Oct. 30, 2007

(51) Int. Cl. G06F 12/08

(52) U.S. Cl. 711/136; 711/E12.022

(57) ABSTRACT

A multi-way cache system includes multi-way cache storage circuitry, a pseudo least recently used (PLRU) tree state representative of a PLRU tree, the PLRU tree having a plurality of levels, and PLRU control circuitry coupled to the multi-way cache storage circuitry and the PLRU tree state. The PLRU control circuitry has programmable PLRU tree level update enable circuitry which selects Y levels of the plurality of levels of the PLRU tree to be updated. The PLRU control circuitry, in response to an address hitting or resulting in an allocation in the multi-way cache storage circuitry, updates only the selected Y levels of the PLRU tree state.

### BACKGROUND

1. Field

This disclosure relates generally to caches, and more specifically, to pseudo least recently used cache replacement.

2. Related Art

Ordinary cache structures generally do not provide good performance with streaming or transient data that is not likely to be re-used. In many real world applications, the amount of streaming data being processed is generally many times larger than the capacity of any available cache(s). As a result, it is likely that the entire cache contents will be overwritten by the streaming data. This has at least two negative effects. First, any re-usable data has been displaced by the streaming data. Second, the streaming data only gets used once but has filled the cache. As a result of these two negative effects, the cache is much less effective at improving the performance of a data processing system by minimizing accesses to slower, more distant memory.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates, in block diagram form, a data processing system in accordance with one embodiment of the present invention.

FIG. 2 illustrates, in block diagram form, a portion of a cache of FIG. 1 in accordance with one embodiment of the present invention.

FIG. 3 illustrates, in partial block diagram form and partial schematic diagram form, a portion of control circuitry of FIG. 2 in accordance with one embodiment of the present invention.

FIG. 4 illustrates, in tabular form, PLRU bit update rules in accordance with one embodiment of the present invention.

FIGS. 5-9 illustrate, in state diagram form, a PLRU replacement method for one set of an 8-way set associative cache using a binary tree having 7 nodes in accordance with the prior art.

FIGS. 10-14 illustrate, in state diagram form, a PLRU replacement method for one set of an 8-way set associative cache using a binary tree having 7 nodes in accordance with one embodiment of the present invention.

FIG. 15 illustrates, in flow diagram form, a method for performing PLRU cache replacement in accordance with one embodiment of the present invention.

### DETAILED DESCRIPTION

A new replacement methodology and its associated circuitry has been developed to allow a cache to more efficiently handle situations in which a large amount of streaming or transient data is received. In addition, the new replacement approach does not penalize the performance of software that does not use a large amount of streaming or transient data. Thus the new cache replacement approach can be used for software that uses a large amount of streaming or transient data, for software that uses a small amount of streaming or transient data, for software that uses no streaming or transient data, and for software in which the presence or amount of streaming or transient data is unknown.

In addition, for some embodiments, it is possible to use the present invention to program cache replacement to be more efficient for streaming or transient data in one or more particular ways and sets (e.g. way 3, set 0), while programming a different set in a different way (e.g. way 5, set 4) and/or programming a different set in the same way (e.g. way 3, set 3) and/or programming a same set in a different way (e.g. way 1, set 0) to be more efficient for non-streamed or non-transient data. Thus for some embodiments, each combination of way and set may be programmed separately. By enabling “Y” levels of the PLRU tree (between none and all inclusive) for updating, the age of new cache entries that are allocated are marked somewhere between the least recently used (LRU) and the most recently used (MRU), inclusive. Thus this programmability allows more granularity on a per way and per set basis for controlling how soon a cache entry will be available for replacement. Note that a cache hit on an entry can be used in some embodiments to change how soon a cache entry will be available for replacement.

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Brackets are used herein to indicate the conductors of a bus or a plurality of signals or the bit locations of a value. For example, “bus 50 [7:0]”, “bus [7:0] 50, “conductors [7:0] of bus 60”, or other permutations thereof, indicates the eight lower order conductors of bus 60; “HIT_WAY [0:7] 50 signals”, “HIT_WAY [0:7] signals 50”, “HIT_WAY [0:7] conductors 50”, or other permutations thereof, indicates the eight lower order signals of a plurality of signals 50; and “address bits [7:0]”, “ADDRESS [7:0]”, or other permutations thereof, indicates the eight lower order bits of an address value.

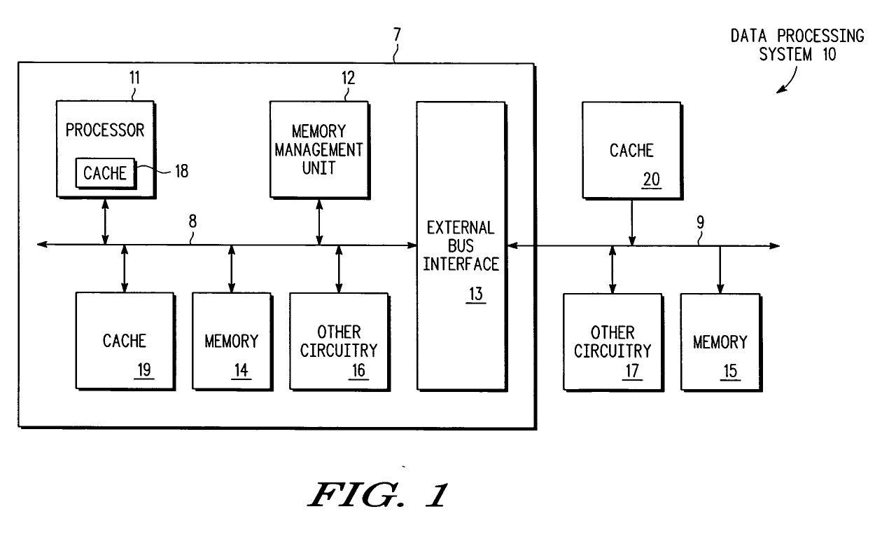

The connectivity of FIGS. 1-15 will now be described.

FIG. 1 illustrates, in block diagram form, a data processing system 10 in accordance with one embodiment of the present invention. In the illustrated embodiment, data processing system 10 has an integrated circuit 7. The integrated circuit has a processor 11, a memory management unit 12, a cache 19, a memory 14, other circuitry 16, and an external bus interface 13 that are all bi-directionally coupled by way of bus 8. Integrated circuit 7 and the circuitry therein is also bi-directionally coupled to an external bus 9 by way of external bus interface 13. In the illustrated embodiment, cache 20, memory 15, and other circuitry are bi-directionally coupled to external bus 9. External bus 9 is called an “external” bus because it goes external to integrated circuit 7. In the illustrated embodiment, processor 11 has a cache 18. In an alternate embodiment, one or more of caches 18, 19, and 20 may be located anywhere within data processing system 10. Alternate embodiments may have only cache 18, only cache 19, only cache 20, or any combination of caches 18-20. In addition, alternate embodiments may have one or more caches represented by each of caches 18-20. For example, cache 18 may represent a data cache and an instruction cache. Caches 18-20 may be any type of cache, and may be the same type of cache, or different types of caches. Other circuitry 16 and other circuitry 17 may be any type of circuitry.

Alternate embodiments of data processing system 10 may have any circuitry that includes one or more caches (e.g. caches 18-20). Aside from the one or more caches (e.g. caches 18-20), the remaining circuitry illustrated in FIG. 1 may or may not be included in alternate embodiments of system 10. In addition, alternate embodiments of system 10 may include additional circuitry which is not illustrated in FIG. 1. Also, in alternate embodiments, any one or more portions of system 10 may be integrated on a same integrated circuit.

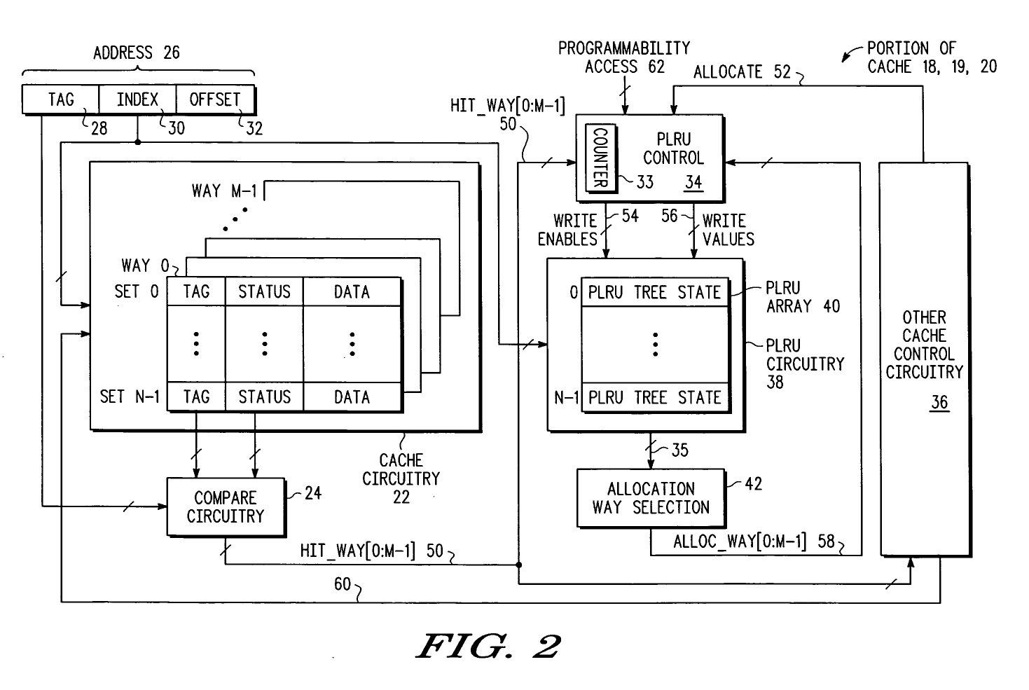

FIG. 2 illustrates a portion of any one or more of caches 18-20 of FIG. 1 in accordance with one embodiment. Alternate embodiments of caches 18-20 may use a different structure than that illustrated in FIG. 2, and may use different structures than each other. The cache 18-20 illustrated in FIG. 2 has “N” sets and “M” ways. The one or more caches in alternate embodiments may each have any number of sets and any number of ways.

In the illustrated embodiment, cache circuitry 22 stores tag, status, and data information for the cache entries. Address 26 includes tag 28, index 30, and offset 32. Index 30 is provided to cache circuitry 22. Compare circuitry 24 is coupled to receive tag 28 and is coupled to cache circuitry 22 to receive tag and status information. Based on this received information, compare circuitry 24 determines whether there has been a cache hit or a cache miss. In the illustrated embodiment, a plurality of hit/miss signals labeled HIT_WAY[0:M−1] 50 are provided to PLRU control circuitry 34 and to other cache control circuitry 36. Each HIT_WAY[0:M−1] 50 signal indicates whether or not there has been a cache hit for its corresponding way in cache circuitry 22. Alternate embodiments may use a cache miss signal in addition to or instead of a cache hit signal.

Other cache control circuitry 36 is coupled to PLRU control circuitry 34 to provide an allocate signal 52, and other cache control circuitry 36 is coupled to cache circuitry 22 by way of conductors or signals 60. In alternate embodiments, other cache control circuitry 36 and PLRU control circuitry 34 may be bi-directionally coupled by other signals (not shown). In alternate embodiments, other cache control circuitry 36 may be coupled to all portions of cache 18-20 that receive cache control signals or that provide information that is needed in order to perform cache control. For example, in some embodiments, cache control circuitry 36 may be coupled to all of the circuit blocks illustrated in FIG. 2.

In the illustrated embodiment, PLRU control circuitry 34 has a counter 33. Alternate embodiments may not have a counter 33. In the illustrated embodiment, PLRU control circuitry 34 receives an ALLOC_WAY[0:M−1] 58 signal for each of the M ways of cache 18-20. PLRU control circuitry 34 also receives programmable access control signals 62. PLRU control circuitry 34 is coupled to PLRU circuitry 38 to provide a plurality of write enable signals 54 and a plurality of write values 56. PLRU circuitry 38 has a PLRU array 40. PLRU array 40 stores N PLRU tree states, where each PLRU tree state represents node values for a corresponding PLRU tree. PLRU circuitry 38 is coupled to allocation way selection circuitry 46 by way of conductors or signals 35. Note that elements 35, 50, 52, 54, 56, 60, and 62 and any arrows without a reference number in FIG. 2 may be considered to be one or more signals or one or more conductors in alternate embodiments, regardless of whether a hash line is used in FIG. 2.

Although one type of architecture for caches 18-20 has been illustrated in FIG. 2, alternate embodiments of caches 18-20 may use any desired or appropriate architecture. The architecture illustrated in FIG. 2 is merely intended to be one possible representative architecture. Any cache architecture that allows for the desired cache replacement may be used. Note that for one embodiment, the cache 18-20 illustrated in FIG. 2 may function in a same or similar manner as prior art caches, with the exception of how cache 18-20 handles cache replacement. In alternate embodiments, cache 18-20 may also function differently than prior art caches in other manners aside from cache replacement.

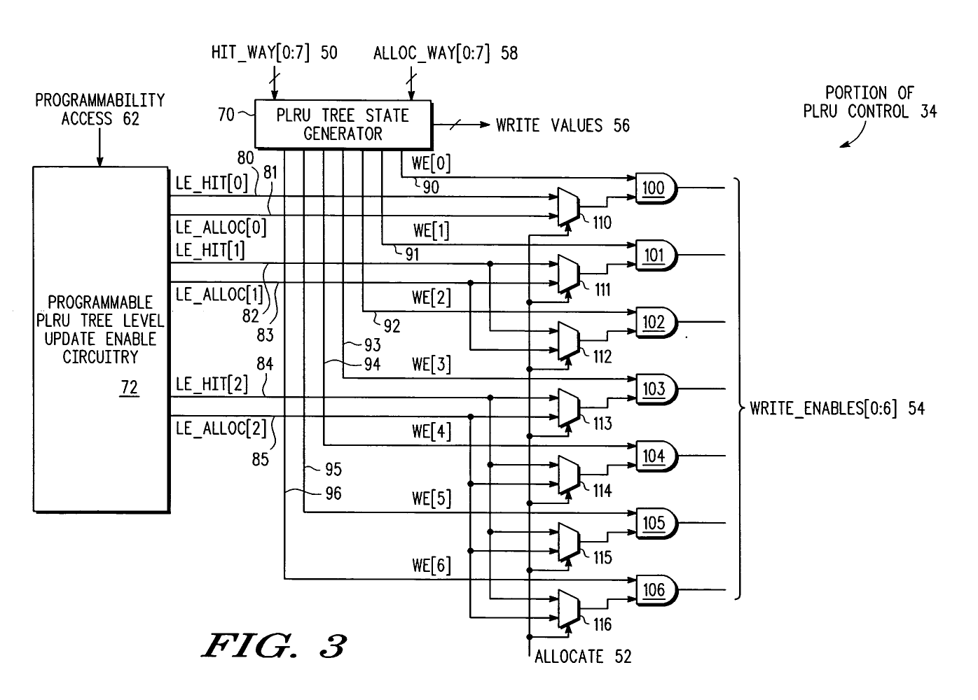

FIG. 3 illustrates a portion of PLRU control circuitry 34 of FIG. 2 applicable to an 8 way set associative cache. Although the circuitry illustrated in FIG. 3 is used with an 8 way cache, this circuitry can be modified to work with a cache having any number of ways (e.g. the M way cache of FIG. 2). Alternate embodiments of FIG. 3 may be used in a cache that has any number of ways.

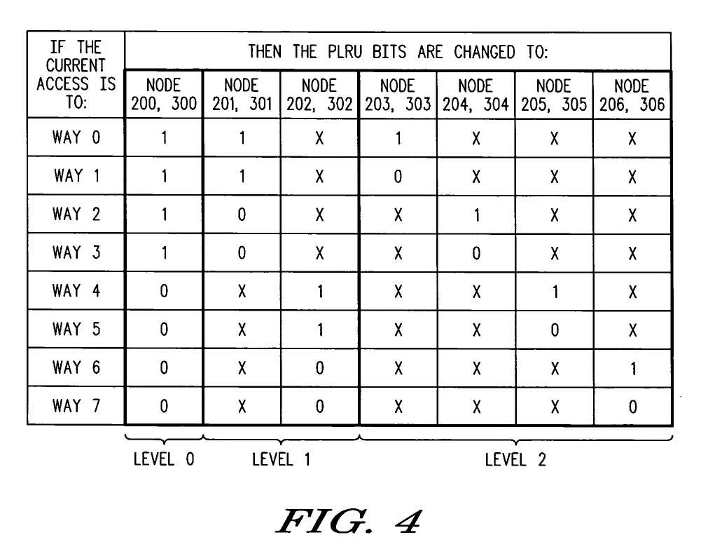

In the embodiment illustrated in FIG. 3, PLRU control circuitry 34 has PLRU tree state generator circuitry 70 and programmable PLRU tree level update enable circuitry 72. PLRU tree state generator 70 receives HIT_WAY[0:7] signals 50 and ALLOC_WAY[0:7] signals 58 and provides write enable signals WE[0:6] 90-96 and provides write values 56 (see e.g., values illustrated in FIG. 4). Programmable PLRU tree level update enable circuitry 72 receives programmable access signal 62 and provides LE_HIT[0:2] signals 80, 82, and 84, and provides LE_ALLOC [0:2] signals 81, 83, and 85.

In the embodiment illustrated in FIG. 3, multiplexers (MUXes) 110-116 and AND gates 100-106 are used to generate write enable signals WRITE_ENABLES[0:6] 54 using signals WE[0:6] 90-96, signals LE_HIT[0:2] 80, 82, 84, signals LE_ALLOC [0:2] 81, 83, 85, and allocate signal 52 as inputs.

In the illustrated embodiment, AND gate 100 has a first input coupled to PLRU tree state generator 70 for receiving signal WE[0] 90. MUX 110 has a first input coupled to circuitry 72 for receiving LE_HIT[0] signal 80, has a second input coupled to circuitry 72 for receiving LE_ALLOC[0] signal 81, and has a select input coupled to other cache control circuitry 36 (see FIG. 2) to receive allocate signal 52. Allocate signal 52 selects which input, LE_HIT[0] 80 or LE_ALLOC[0] 81, is provided from the output of MUX 110 to a second input of AND gate 100. This second input to AND gate 100 functions as an enable to either allow or prevent the WE[0] signal 90 from passing through and determining the value of WRITE_ENABLE[0] signal of signals 54.

In the illustrated embodiment, AND gate 101 has a first input coupled to PLRU tree state generator 70 for receiving signal WE[1] 91. MUX 111 has a first input coupled to circuitry 72 for receiving LE_HIT[1] signal 82, has a second input coupled to circuitry 72 for receiving LE_ALLOC[1] signal 83, and has a select input coupled to other cache control circuitry 36 (see FIG. 2) to receive allocate signal 52. Allocate signal 52 selects which input, LE_HIT[1] 82 or LE_ALLOC[1] 83, is provided from the output of MUX 111 to a second input of AND gate 101. This second input to AND gate 101 functions as an enable to either allow or prevent the WE[1] signal 91 from passing through and determining the value of WRITE_ENABLE[1] signal of signals 54.

In the illustrated embodiment, AND gate 102 has a first input coupled to PLRU tree state generator 70 for receiving signal WE[2] 92. MUX 112 has a first input coupled to circuitry 72 for receiving LE_HIT[1] signal 82, has a second input coupled to circuitry 72 for receiving LE_ALLOC[1] signal 83, and has a select input coupled to other cache control circuitry 36 (see FIG. 2) to receive allocate signal 52. Allocate signal 52 selects which input, LE_HIT[1] 82 or LE_ALLOC[1] 83, is provided from the output of MUX 112 to a second input of AND gate 102. This second input to AND gate 102 functions as an enable to either allow or prevent the WE[2] signal 92 from passing through and determining the value of WRITE_ENABLE[2] signal of signals 54.

In the illustrated embodiment, AND gate 103 has a first input coupled to PLRU tree state generator 70 for receiving signal WE[3] 93. MUX 113 has a first input coupled to circuitry 72 for receiving LE_HIT[2] signal 84, has a second input coupled to circuitry 72 for receiving LE_ALLOC[2] signal 85, and has a select input coupled to other cache control circuitry 36 (see FIG. 2) to receive allocate signal 52. Allocate signal 52 selects which input, LE_HIT[2] 84 or LE_ALLOC[2] 85, is provided from the output of MUX 113 to a second input of AND gate 103. This second input to AND gate 103 functions as an enable to either allow or prevent the WE[3] signal 93 from passing through and determining the value of WRITE_ENABLE[3] signal of signals 54.

In the illustrated embodiment, AND gate 104 has a first input coupled to PLRU tree state generator 70 for receiving signal WE[4] 94. MUX 114 has a first input coupled to circuitry 72 for receiving LE_HIT[2] signal 84, has a second input coupled to circuitry 72 for receiving LE_ALLOC[2] signal 85, and has a select input coupled to other cache control circuitry 36 (see FIG. 2) to receive allocate signal 52. Allocate signal 52 selects which input, LE_HIT[2] 84 or LE_ALLOC[2] 85, is provided from the output of MUX 114 to a second input of AND gate 104. This second input to AND gate 104 functions as an enable to either allow or prevent the WE[4] signal 94 from passing through and determining the value of WRITE_ENABLE[4] signal of signals 54.

In the illustrated embodiment, AND gate 105 has a first input coupled to PLRU tree state generator 70 for receiving signal WE[5] 95. MUX 115 has a first input coupled to circuitry 72 for receiving LE_HIT[2] signal 84, has a second input coupled to circuitry 72 for receiving LE_ALLOC[2] signal 85, and has a select input coupled to other cache control circuitry 36 (see FIG. 2) to receive allocate signal 52. Allocate signal 52 selects which input, LE_HIT[2] 84 or LE_ALLOC[2] 85, is provided from the output of MUX 115 to a second input of AND gate 105. This second input to AND gate 105 functions as an enable to either allow or prevent the WE[5] signal 95 from passing through and determining the value of WRITE_ENABLE[5] signal of signals 54.

In the illustrated embodiment, AND gate 106 has a first input coupled to PLRU tree state generator 70 for receiving signal WE[6] 96. MUX 116 has a first input coupled to circuitry 72 for receiving LE_HIT[2] signal 84, has a second input coupled to circuitry 72 for receiving LE_ALLOC[2] signal 85, and has a select input coupled to other cache control circuitry 36 (see FIG. 2) to receive allocate signal 52. Allocate signal 52 selects which input, LE_HIT[2] 84 or LE_ALLOC[2] 85, is provided from the output of MUX 116 to a second input of AND gate 106. This second input to AND gate 106 functions as an enable to either allow or prevent the WE[6] signal 96 from passing through and determining the value of WRITE_ENABLE[6] signal of signals 54.

FIG. 4 illustrates, in tabular form, PLRU bit update rules in accordance with one embodiment of the present invention. PLRU tree state generator 70 uses the information from FIG. 4 to provide write values 56 and signals WE[0:6] 90-96. Note that there is a write enable signal (one of WE[0:6] 90-96) and a write value (one of write values 56) for each node (nodes 0-6) of the PLRU tree. In some prior art, the information provided in FIG. 4 was used to determine the write enable signals themselves (e.g. corresponding to WRITE_ENABLES[0:6] signals 54 in FIG. 2), and thus all levels of the PLRU tree were potentially subject to change. In the prior art, there was no flexibility in determining which levels of the PLRU tree could potentially have their bits changed.

Referring again to FIG. 3, by modifying the PLRU control circuitry 34 by adding MUXes 110-116 and gates 100-106 it is now possible to select any number of levels of the PLRU tree that may be made available for updating. And for some embodiments, using the level selecting circuitry before the PLRU array 40 is accessed, rather than after the PLRU array 40 is accessed (e.g. in the allocation way selection circuitry 42) allows smaller, more space efficient level selecting circuitry to be used. However, using slightly different circuitry, alternate embodiments may perform the level selecting as part of the allocation way selection process performed in the allocation way selection circuitry 42.

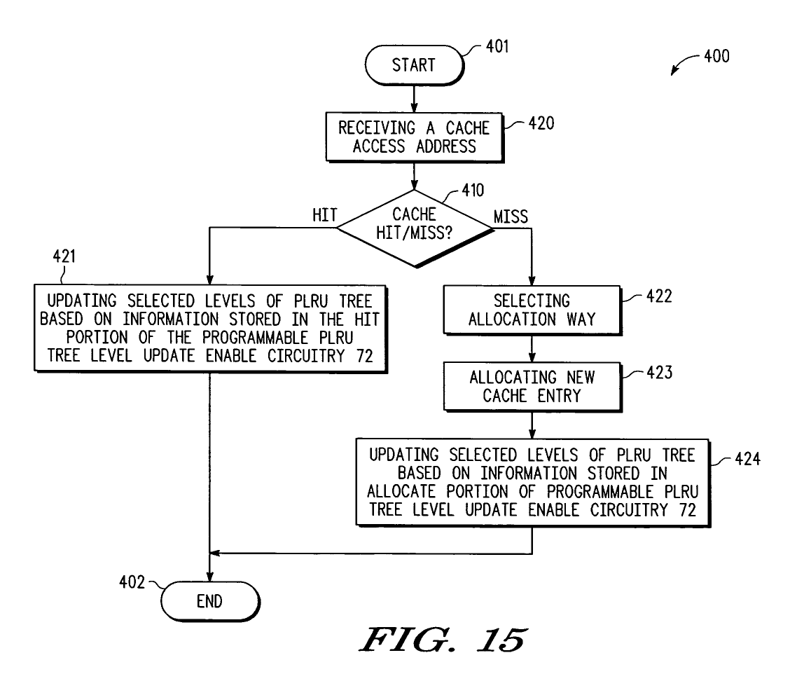

FIG. 15 illustrates a flow 400 for performing PLRU cache replacement for the caches 18-20 of FIG. 1 in accordance with one embodiment of the present invention. Flow 400 starts at start oval 401 and proceeds to block 420 where the step “receiving a cache access address” is performed. From block 420, flow 400 proceeds to decision diamond 410 where a question is asked “cache hit/miss?”. If a cache hit occurs (e.g. at least one of HIT_WAY[0:M−1] 50 signals of FIG. 2 is asserted), flow 400 proceeds to block 421 where the step of “updating selected levels of PLRU tree based on information stored in the hit portion of the programmable PLRU tree level update enable circuitry 72” is performed. From block 421 the flow proceeds to end oval 402 where the flow 400 ends. If a cache miss occurs (e.g. all of HIT_WAY[0:M−1] 50 signals of FIG. 2 are negated), flow 400 proceeds from block 410 to block 422 where the step of “selecting allocation way” is performed. From block 422 the flow proceeds to block 423 where the step of “allocating new cache entry” is performed. From block 423 the flow 400 proceeds to block 424 where the step “updating selected levels of PLRU tree based on information stored in allocate portion of programmable PLRU tree level update enable circuitry” is performed. From block 424 the flow 400 proceeds to end oval 402 where the flow 400 ends.

The operation of various embodiments of the methods and circuitry of FIGS. 1-15 will now be described.

FIG. 2 illustrates a portion of any one or more of caches 18, 19, and/or 20 of FIG. 1. Address 26 has a tag portion 28, an index portion 30, and an offset portion 32. The index portion 30 is used to select a set in cache circuitry 22. The tag information from cache circuitry 22 is compared to tag 28 and qualified by status information (e.g. valid bits) from cache circuitry 22. The result of the compare and qualification (e.g. match and valid) determines whether or not a cache hit occurs. This portion of cache 18, 19 and/or 20 may operate in a standard prior art manner.

The cache illustrated in FIG. 2 has “N” sets and “M” ways. Each set has a corresponding PLRU tree state in PLRU array 40. PLRU array 40 is used to store the existing PLRU tree states for all N sets. The existing PLRU tree states are traversed using allocation way selection circuitry 42 to select the way that will be allocated for a new cache entry. PLRU control circuitry 34 controls the updating of the PLRU tree states in PLRU array 40.

In the illustrated embodiment, other cache control circuitry 36 provides an allocate signal 52 to PLRU control 34. This allocate signal 52 indicates whether or not to allocate when a cache miss has occurred. Other cache control circuitry 36 also provides control signals 60 to cache circuitry 22 (e.g. for read/write control).

Although FIG. 2 illustrates specific circuitry than may be used to implement a portion of cache 18, 19, and/or 20 of FIG. 1, alternate embodiments may use any desired circuitry that allows the PLRU tree states in PLRU array 40 to be updated on a per level basis. A wide variety of circuit implementations may be used. The circuitry illustrated in FIG. 2 is merely intended to illustrate one possible embodiment.

FIG. 3 illustrates a portion of PLRU control circuitry 34 of FIG. 2 applicable to an 8 way set associative cache. Although the circuitry illustrated in FIG. 3 is used with an 8 way cache, this circuitry can be modified to work with a cache have any number of ways (e.g. the M way cache of FIG. 2). In the illustrated embodiment, PLRU control 34 has programmable PLRU tree level update enable circuitry 72 that may be programmed (e.g. by the user of data processing system 10 by way of programmability access 62) to select which “Y” levels of the PLRU tree may be enabled for updating. In one embodiment, programmability access 62 may be coupled to a bus (e.g. bus 8 and/or 9 in FIG. 1) to allow write access and optionally read access to circuitry 72. In an alternate embodiment, programmability access 62 may be coupled to other circuitry (e.g. fuses, memory, latches, or any other type of storage circuitry) (not shown) that provides the desired values or information to circuitry 72 for programming. In some embodiments, circuitry 72 may have a first portion for enabling updates to selected levels of the PLRU tree when a new cache entry is allocated, and a second portion for enabling updates to selected levels of the PLRU tree when a cache hit occurs. Alternate embodiments may only have a first portion for allocation, may only have a second portion for hits, or may have both first and second portions to separately control the enablement of updates for allocation and hits.

Note that if no levels of the PLRU tree are enabled for updating, then new cache entries that are allocated are marked least recently used (LRU) and will be the next to be replaced. If all levels of the PLRU tree are enabled for updating, then new cache entries that are allocated are marked most recently used (MRU) and will be the last to be replaced. By enabling “Y” levels of the PLRU tree (between none and all) for updating, the age of new cache entries that are allocated are marked somewhere between the least recently used and the most recently used. Thus this programmability allows more granularity in controlling how soon a cache entry will be available for replacement. Note that a cache hit on an entry can be used in some embodiments to change how soon a cache entry will be available for replacement.

In the embodiment illustrated in FIG. 3, LE_HIT[0] 80 is used to enable updates to nodes within level 0 of the PLRU tree for cache hits. Similarly, LE_ALLOC[0] 81 is used to enable updates to nodes within level 0 of the PLRU tree for cache allocation. LE_HIT[1] 82 is used to enable updates to nodes within level 1 of the PLRU tree for cache hits. Similarly, LE_ALLOC[1] 83 is used to enable updates to nodes within level 1 of the PLRU tree for cache allocation. LE_HIT[2] 84 is used to enable updates to nodes within level 2 of the PLRU tree for cache hits. Similarly, LE_ALLOC[2] 85 is used to enable updates to nodes within level 2 of the PLRU tree for cache allocation.

PLRU tree state generator 70 uses the information from FIG. 4 to provide write values 56 and signals WE[0:6] 90-96. Note that there is a write enable signal (one of WE[0:6] 90-96) and a write value (one of write values 56) for each node (nodes 0-6) of the PLRU tree. In one embodiment, a “1” or a “0” in an entry in FIG. 4 indicates that the corresponding write enable signal (one of WE[0:6] 90-96) is asserted, and the corresponding write value (one of write values 56) is a “1” or a “0”, respectively. An “X” in an entry in FIG. 4 indicates that the corresponding write enable signal (one of WE[0:6] 90-96) is negated, and the corresponding write value (one of write signals 56) is a don't care since no write will take place. Note that in the illustrated embodiment, separate signals are used to select the way for hits (HIT_WAY[0:7] 50) and the way for allocation (ALLOC_WAY[0:7] 58). For a cache hit, HIT_WAY[0:7] 50 signals are used to select which row in FIG. 4 (i.e. which way) is to be used. For cache allocation, ALLOC_WAY[0:7] 58 signals are used to select which row in FIG. 4 (i.e. which way) is to be used. Alternate embodiments may use the same signals to select the way for both hits and allocations.

In one embodiment, multiplexers (MUXes) 110-116 use an allocate signal 52 to determine whether a hit or allocation is occurring and thus select the appropriate signals (either all of LE_HIT[0:2] 80, 82, 84 or all of LE_ALLOC[0:2] 81, 83, 85) to be passed through to gates 100-106. Thus, the output of MUXes 110-116 are effectively used to determine whether the write enable signals WE[0:6] 90-96 are passed through as WRITE_ENABLES [0:6] 54, or whether WRITE_ENABLES [0:6] 54 are negated.

In an alternate embodiment, it may be desirable to periodically ignore all of LE_HIT[0:2] 80, 82, 84 signals and all of LE_ALLOC[0:2] 81, 83, 85 signals and update all of the levels in the PLRU tree by directly passing through the WE[0:6] 90-96 signals as the WRITE_ENABLES [0:6] 54. This may prevent harmonic behavior that prevents full utilization of the cache due to repeating access patterns in address 26 (see FIG. 2). One way to implement this may be to include a counter 33 (see FIG. 2) in PLRU control 34 which counts the number of allocations that have occurred. Once the counter 33 has reached a predetermined value, all levels of the PLRU tree may be updated and the counter 33 may be reset. Alternate embodiments may use circuitry other than a counter to reset all levels of the PLRU tree whenever desired or appropriate.

Although FIG. 3 illustrates specific circuitry than may be used to implement a portion of PLRU control 34, alternate embodiments may use any desired circuitry that allows the PLRU tree states in PLRU array 40 (see FIG. 2) to be updated on a per level basis. A wide variety of circuit implementations may be used. The circuitry illustrated in FIG. 3 is merely intended to illustrate one possible embodiment.

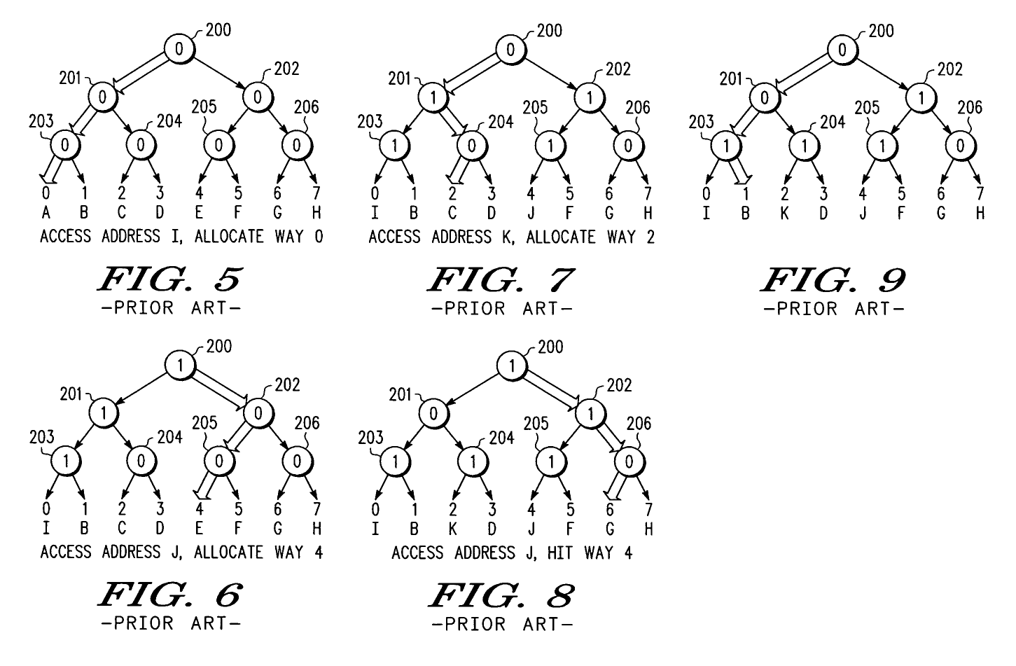

FIGS. 5-8 illustrate a prior art PLRU replacement method for one set of an 8-way set associative cache using a binary tree having 7 nodes labeled 200-206. Note that FIG. 5 assumes that ways 0-7 of the cache are storing addresses A-H, respectively, and that the value of all nodes is “0”. In the illustrated embodiment, the thick arrows indicate the next way for allocation. Note also that for the illustrated embodiment, the binary tree is only traversed on allocation. For alternate embodiments, the binary tree may be traversed on cache hits, cache misses, or any other desired and appropriate occurrence or combination of occurrences. Of course the path of traversal of the tree will vary accordingly. The binary tree of FIG. 5 is traversed when a miss occurs in the cache and it has been determined that allocation is desired. The binary tree of FIG. 5 is traversed in the following manner: a “0” in a node means “go left”, and a “1” in a node means “go right”. So for example, referring to FIG. 5, when an access to address I is received, traversal of the binary tree starts at node 200. Because node 200 has a value “0”, the traversal goes left to node 201. Because node 201 has a value “0”, the traversal goes left to node 203. Because node 203 has a value “0”, the traversal goes left to way 0. Since way 0 has been selected, address I replaces address A in way 0 of the cache. The prior art PLRU replacement method requires that all of the nodes in the path to the selected way (i.e. way 0) are changed to point away from the way that was just selected (i.e. way 0). Referring to FIG. 6, this method results in nodes 200, 201, and 203 having their respective states changed to a “1”.

Referring to FIG. 6, when an access to address J is received, traversal of the binary tree starts at node 200. Because node 200 has a value “1”, the traversal goes right to node 202. Because node 202 has a value “0”, the traversal goes left to node 205. Because node 205 has a value “0”, the traversal goes left to way 4. Since way 4 has been selected, address J replaces address E in way 4 of the cache. The prior art PLRU replacement method requires that all of the nodes in the path to the selected way (i.e. way 4) are changed to point away from the way that was just selected (i.e. way 4). Referring to FIG. 7, this method results in node 200 having its state changed to a “0”, and nodes 202 and 205 having their respective states changed to a “1”.

Referring to FIG. 7, when an access to address K is received, traversal of the binary tree starts at node 200. Because node 200 has a value “0”, the traversal goes left to node 201. Because node 201 has a value “1”, the traversal goes right to node 204. Because node 204 has a value “0”, the traversal goes left to way 2. Since way 2 has been selected, address K replaces address C in way 2 of the cache. The prior art PLRU replacement method requires that all of the nodes in the path to the selected way (i.e. way 2) are changed to point away from the way that was just selected (i.e. way 2). Referring to FIG. 8, this method results in node 201 having its state changed to a “0”, and nodes 200 and 204 having their respective states changed to a “1”.

Referring to FIG. 8, when an access to address J is received, a cache hits occurs because the address J is already stored in the cache. Traversal of the binary tree is thus not needed because no allocation is required. However, the prior art PLRU replacement method requires that all of the nodes in the path to the selected way (i.e. way 4) are changed to point away from the way that was just selected (i.e. way 4). Referring to FIG. 9, this method results in node 200 having its state changed to a “0”. Note that FIG. 9 illustrates the traversal path that would be used for allocation purposes on the next cache miss.

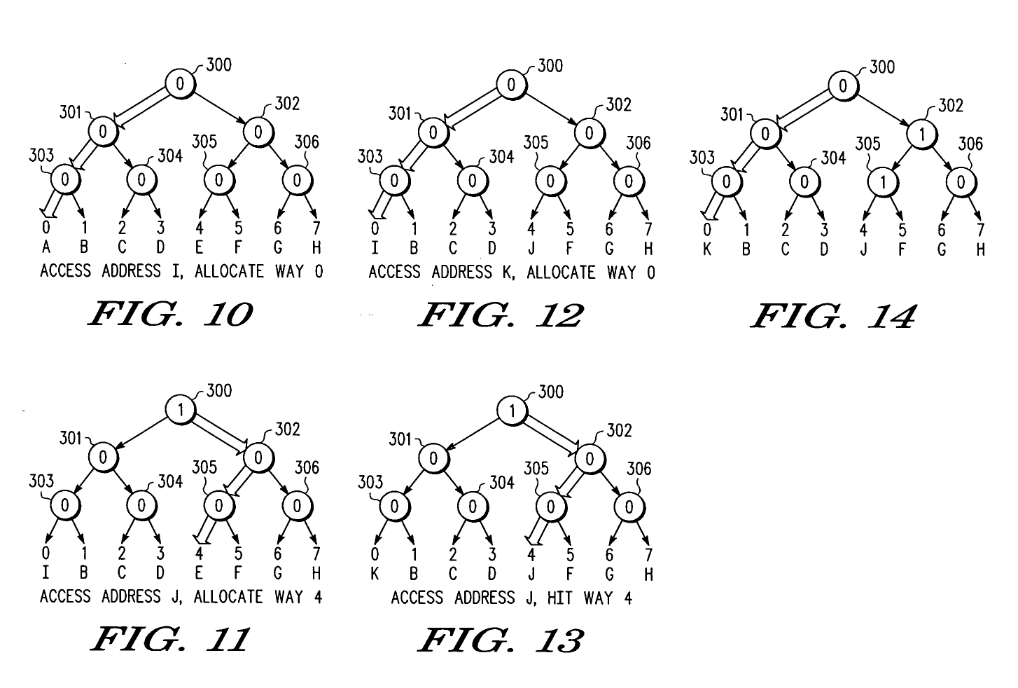

FIGS. 10-14 illustrate one embodiment of a new PLRU replacement method for one set of an 8-way set associative cache using a binary tree having 7 nodes labeled 300-306. Note that FIG. 10 assumes that ways 0-7 of the cache are storing addresses A-H, respectively, and that the value of all nodes is “0”. In the illustrated embodiment, the thick arrows indicate the next victim on allocation. Note also that for the illustrated embodiment, the binary tree is only traversed on allocation. For alternate embodiments, the binary tree may be traversed on cache hits, cache misses, or any other desired and appropriate occurrence or combination of occurrences. Of course the path of traversal of the tree will vary accordingly. The binary tree of FIG. 10 is traversed when a miss occurs in the cache and it has been determined that allocation is desired. The binary tree of FIG. 10 is traversed in the following manner: a “0” in a node means “go left”, and a “1” in a node means “go right”. So for example, referring to FIG. 10, when an access to address I is received, traversal of the binary tree starts at node 300. Because node 300 has a value “0”, the traversal goes left to node 301. Because node 301 has a value “0”, the traversal goes left to node 303. Because node 303 has a value “0”, the traversal goes left to way 0. Since way 0 has been selected, address I replaces address A in way 0 of the cache. The new PLRU replacement method selects which one or more levels of the binary tree may be updated with new node values when a new cache entry is allocated. Note that the first level (level 0) includes node 300, the second level (level 1) includes nodes 301 and 302, and the third level (level 2) includes nodes 303-306. In some embodiments, programmable PLRU tree level update enable circuitry 72 (see FIG. 3) may be used to store the information as to which levels may be updated with new node values when a new cache entry is allocated. In the example illustrated in FIG. 10, when a new cache entry is allocated, circuitry 72 (see FIG. 3) has been programmed to only update level 0 (level 1 and level 2 are not enabled for updates). Thus, only node 300 will be updated when a new cache entry is allocated. Referring to FIG. 11, this method results in node 300 having its state changed to a “1”.

Referring to FIG. 11, when an access to address J is received, traversal of the binary tree starts at node 300. Because node 300 has a value “1”, the traversal goes right to node 302. Because node 302 has a value “0”, the traversal goes left to node 305. Because node 305 has a value “0”, the traversal goes left to way 4. Since way 4 has been selected, address J replaces address E in way 4 of the cache. The new PLRU replacement method in this example only updates level 0 (node 300) on allocation to point away from the way that was just selected (i.e. way 4). Referring to FIG. 12, this method results in node 300 having its state changed to a “0”.

Referring to FIG. 12, when an access to address K is received, traversal of the binary tree starts at node 300. Because node 300 has a value “0”, the traversal goes left to node 301. Because node 301 has a value “0”, the traversal goes left to node 303. Because node 303 has a value “0”, the traversal goes left to way 0. Since way 0 has been selected, address K replaces address I in way 0 of the cache. The new PLRU replacement method in this example only updates level 0 (node 300) on allocation to point away from the way that was just selected (i.e. way 0). Referring to FIG. 13, this method results in node 300 having its state changed to a “1”. Note that unlike the prior art method described in FIG. 7, address K was allocated to way 0 instead of to way 2 because address I in way 0 had not been hit. Since address I has not been recently hit, address I is more likely to be streaming or transient data that is not re-used and is therefore replaceable.

Referring to FIG. 13, when an access to address J is received, a cache hits occurs because the address J is already stored in the cache. Traversal of the binary tree is thus not needed because no allocation is required. However, the new PLRU replacement method in this example updates levels 0-2 (node 300-306) on hits to point away from the way that was just selected (i.e. way 4). Referring to FIG. 14, this method results in node 300 having its state changed to a “0” and nodes 302 and 305 having its state changed to a “1”. Note that FIG. 14 illustrates the traversal path that would be used for allocation purposes on the next cache miss. Note that because there was a hit on J in FIG. 13, the node values have been effectively changed to point away from J so that J will not be replaced in the immediate future.

By now it should be appreciated that there has been provided a new cache replacement methodology and its associated circuitry to allow a cache to more efficiently handle situations in which streaming or transient data may be received. In addition, the new replacement approach does not penalize the performance of software that does not use streaming or transient data. In one embodiment, the new PLRU replacement method selects which one or more levels of the binary tree may be updated with new node values when a new cache entry is allocated. For example, the PLRU tree states in PLRU array 40 (see FIG. 3) may be updated on a per level basis. Thus, it is possible to select any number of levels of the PLRU tree that may be made available for updating. Note that if no levels of the PLRU tree are enabled for updating, then new cache entries that are allocated are marked least recently used (LRU) and will be the next to be replaced. If all levels of the PLRU tree are enabled for updating, then new cache entries that are allocated are marked most recently used (MRU) and will be the last to be replaced. By enabling “Y” levels of the PLRU tree (between none and all) for updating, the age of new cache entries that are allocated are marked somewhere between the least recently used and the most recently used. Thus this programmability allows more granularity in controlling how soon a cache entry will be available for replacement. Note that a cache hit on an entry can be used in some embodiments to change how soon a cache entry will be available for replacement.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

In one embodiment, system 10 is a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Although the invention described herein references data caches, alternate embodiments may use an instruction cache, a memory address translation cache, a branch prediction cache, or any other type of cache or combination of caches. The term cache is intended to include any type of cache.

Note that for some embodiments, there may be a bit field or a single bit that indicates whether a corresponding level of the PLRU tree state should be updated. As one example for an 8-way cache, a first bit may indicate whether to update level 1 or not, a second bit may indicate whether to update level 2 or not, and a third bit may indicate whether to update level 3 or not. Note that for some embodiments, setting Y equal to 1 and updating only the top level of the binary tree produces a different traversal, and thus different cache behavior, than setting Y equal to 1 and updating only the bottom level of the binary tree. For some systems in which a cache is used, it may be quite advantageous to be able to make this kind of selection of cache behavior on a per level basis.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

### Additional Text

1. A multi-way cache system (for example 18, 19, 20) comprising:
multi-way cache storage circuitry (for example 22);
a pseudo least recently used (PLRU) tree state (for example 40) representative of a PLRU tree, the PLRU tree having a plurality of levels; and
PLRU control circuitry (for example 34, 38, 40) coupled to the multi-way cache storage circuitry and the PLRU tree state, the PLRU control circuitry having programmable PLRU tree level update enable (for example 72) circuitry which selects Y levels of the plurality of levels of the PLRU tree to be updated, wherein the PLRU control circuitry, in response to an address hitting or resulting in an allocation in the multi-way cache storage circuitry, updates only the selected Y levels of the PLRU tree state.

2. The multi-way cache system of statement 1, further comprising replacement way selection circuitry (for example 42), wherein in response to the address resulting in an allocation in the multi-way cache storage circuitry, the replacement way selection circuitry provides a selected replacement way (for example 58) based on the PLRU tree state.

3. The multi-way cache system of statement 1, wherein the PLRU tree state provides a value of each node of the PLRU tree, wherein the PLRU control circuitry updates only the selected Y levels of the PLRU tree state by updating a value of at least one node within each of the selected Y levels of the PLRU tree state.

4. The multi-way cache system of statement 1, wherein the PLRU control circuitry updates only the selected Y levels of the PLRU tree state in response to an address resulting in an allocation in the multi-way cache storage circuitry.

5. The multi-way cache system of statement 1, wherein the PLRU control circuitry periodically updates all levels of the PLRU tree state in response to an allocation or a hit.

6. The multi-way cache system of statement 1, wherein the PLRU tree includes at least one additional level in addition to the selected Y levels.

7. The multi-way cache system of statement 1, wherein Y is an integer greater than or equal to zero.

8. The multi-way cache system of statement 1 wherein the PLRU tree state is one of a plurality of PLRU tree states (for example 40), each of the plurality of PLRU tree states representative of a PLRU tree for a particular set of a plurality of sets of the multi-way cache.

9. In a multi-way cache, a method comprising:
receiving a cache access address (for example 420);
determining if the cache access address results in a cache hit or a cache miss (for example 40); and
when the cache access address results in a cache miss, the method further comprises:
   using a PLRU tree to select a replacement way of the multi-way cache (for example 422);
   allocating a new cache entry in the selected replacement way (for example 423);
   selecting Y levels of the PLRU tree based on an allocation portion of programmable PLRU tree level enable information; and
   updating only the Y selected levels of the PLRU tree (for example 424).

10. The method of statement 9, wherein when the cache access address results in a cache hit, the method further comprises:
selecting Z levels of the PLRU tree based on a hit portion of programmable PLRU tree level enable for hit information; and
updating only the Z selected levels of the PLRU tree.

11. The method of statement 10, wherein Y and Z are each integers greater than or equal to zero and wherein Y and Z are different integers.

12. The method of statement 9, wherein the PLRU tree includes at least one additional level in addition to the Y levels.

13. The method of statement 9, further comprising:
periodically updating all levels of the PLRU tree.

14. A method comprising:
providing multi-way cache (for example 18, 19, 20) storage circuitry (for example 22);
providing a pseudo least recently used (PLRU) tree state representative of a PLRU tree (for example 40), the PLRU tree having a plurality of levels; and
providing PLRU control circuitry (for example 34, 38, 40) coupled to the multi-way cache storage circuitry and the PLRU tree state, the PLRU control circuitry having programmable PLRU tree level update enable circuitry (for example 72) which selects Y levels of the plurality of levels of the PLRU tree to be updated,
wherein the PLRU control circuitry, in response to an address hitting or resulting in an allocation in the multi-way cache storage circuitry, updates only the selected Y levels of the PLRU tree state.

15. The method of statement 14, further comprising providing replacement way selection circuitry (for example 42), wherein in response to the address resulting in an allocation in the multi-way cache storage circuitry, the replacement way selection circuitry provides a selected replacement way based on the PLRU tree state.

16. The method of statement 15, wherein in response to an address resulting in an allocation in the multi-way cache storage circuitry, the replacement way selection circuitry provides the selected replacement way based on the PLRU tree state prior to the PLRU control circuitry updating only the selected Y levels of the PLRU tree state.

17. The method of statement 14, wherein the PLRU tree state provides a value of each node of the PLRU tree, wherein the PLRU control circuitry updates only the selected Y levels of the PLRU tree state by updating a value of at least one node within each of the selected Y levels of the PLRU tree state.

18. The method of statement 14, wherein the PLRU control circuitry periodically updates all levels of the PLRU tree state.

19. The method of statement 14, wherein the PLRU tree includes at least one additional level in addition to the selected Y levels.

20. The method of statement 14, wherein Y is an integer greater than or equal to zero.

What is claimed is:

1. A multi-way cache system comprising:
multi-way cache storage circuitry;
a pseudo least recently used (PLRU) tree state representative of a PLRU tree, the PLRU tree having a plurality of levels; and
PLRU control circuitry coupled to the multi-way cache storage circuitry and the PLRU tree state, the PLRU control circuitry having programmable PLRU tree level update enable circuitry which selects Y levels of the plurality of levels of the PLRU tree to be updated,
wherein the PLRU control circuitry, in response to an address hitting or resulting in an allocation in the multi-way cache storage circuitry, updates only the selected Y levels of the PLRU tree state.

2. The multi-way cache system of claim 1, further comprising replacement way selection circuitry, wherein in response to the address resulting in an allocation in the multi-way cache storage circuitry, the replacement way selection circuitry provides a selected replacement way based on the PLRU tree state.

3. The multi-way cache system of claim 1, wherein the PLRU tree state provides a value of each node of the PLRU tree, wherein the PLRU control circuitry updates only the selected Y levels of the PLRU tree state by updating a value of at least one node within each of the selected Y levels of the PLRU tree state.

4. The multi-way cache system of claim 1, wherein the PLRU control circuitry updates only the selected Y levels of the PLRU tree state in response to an address resulting in an allocation in the multi-way cache storage circuitry.

5. The multi-way cache system of claim 1, wherein the PLRU control circuitry periodically updates all levels of the PLRU tree state in response to an allocation or a hit.

6. The multi-way cache system of claim 1, wherein the PLRU tree includes at least one additional level in addition to the selected Y levels.

7. The multi-way cache system of claim 1, wherein Y is an integer greater than or equal to zero.

8. The multi-way cache system of claim 1 wherein the PLRU tree state is one of a plurality of PLRU tree states, each of the plurality of PLRU tree states representative of a PLRU tree for a particular set of a plurality of sets of the multi-way cache.

9. In a multi-way cache, a method comprising:
receiving a cache access address;
determining if the cache access address results in a cache hit or a cache miss; and
when the cache access address results in a cache miss, the method further comprises:
using a PLRU tree to select a replacement way of the multi-way cache;
allocating a new cache entry in the selected replacement way;
selecting Y levels of the PLRU tree based on an allocation portion of programmable PLRU tree level enable information; and
updating only the Y selected levels of the PLRU tree.

10. The method of claim 9, wherein when the cache access address results in a cache hit, the method further comprises:
selecting Z levels of the PLRU tree based on a hit portion of programmable PLRU tree level enable for hit information; and
updating only the Z selected levels of the PLRU tree.

11. The method of claim 10, wherein Y and Z are each integers greater than or equal to zero and wherein Y and Z are different integers.

12. The method of claim 9, wherein the PLRU tree includes at least one additional level in addition to the Y levels.

13. The method of claim 9, further comprising:
periodically updating all levels of the PLRU tree.

14. A method comprising:
providing multi-way cache storage circuitry;
providing a pseudo least recently used (PLRU) tree state representative of a PLRU tree, the PLRU tree having a plurality of levels; and
providing PLRU control circuitry coupled to the multi-way cache storage circuitry and the PLRU tree state, the PLRU control circuitry having programmable PLRU tree level update enable circuitry which selects Y levels of the plurality of levels of the PLRU tree to be updated,
wherein the PLRU control circuitry, in response to an address hitting or resulting in an allocation in the multi-way cache storage circuitry, updates only the selected Y levels of the PLRU tree state.

15. The method of claim 14, further comprising providing replacement way selection circuitry, wherein in response to the address resulting in an allocation in the multi-way cache storage circuitry, the replacement way selection circuitry provides a selected replacement way based on the PLRU tree state.

16. The method of claim 15, wherein in response to an address resulting in an allocation in the multi-way cache storage circuitry, the replacement way selection circuitry provides the selected replacement way based on the PLRU tree state prior to the PLRU control circuitry updating only the selected Y levels of the PLRU tree state.

17. The method of claim 14, wherein the PLRU tree state provides a value of each node of the PLRU tree, wherein the PLRU control circuitry updates only the selected Y levels of the PLRU tree state by updating a value of at least one node within each of the selected Y levels of the PLRU tree state.

18. The method of claim 14, wherein the PLRU control circuitry periodically updates all levels of the PLRU tree state.

19. The method of claim 14, wherein the PLRU tree includes at least one additional level in addition to the selected Y levels.

20. The method of claim 14, wherein Y is an integer greater than or equal to zero.
